(19) United States
(12) Patent Application Publication
(10) Pub. No.: US 2026/0083992 A1
(43) Pub. Date: Mar. 26, 2026

(54) SPRING RELIEF HARNESS DORSAL ASSEMBLY

(71) Applicant: Safewaze LLC, Concord, NC (US)

(72) Inventors: Clarke Jewell, Cornelius, NC (US); Cortland G. Schurian, Concord, NC (US)

(73) Assignee: Safewaze LLC, Concord, NC (US)

(21) Appl. No.: 19/341,964

(22) Filed: Sep. 26, 2025

Related U.S. Application Data
(60) Provisional application No. 63/699,589, filed on Sep. 26, 2024.

(51) Int. Cl. A62B 35/04; A62B 35/00

(52) U.S. Cl. CPC A62B 35/04; A62B 35/0018; A62B 35/0037

(57) ABSTRACT

An apparatus for reducing wearer fatigue for use in a wearable safety harness system includes a dorsal chassis capable of engagement with one or more shoulder safety straps and one or more lower torso webbing straps, an attachment subassembly comprising of a D-ring, a self-retracting lifeline attachment point, lower torso webbing strap attachment point, and a force-reduction mechanism. The attachment subassembly is attached to the dorsal chassis via the force-reduction mechanism such that force-reduction mechanism absorbs vertical forces produced by the weight of a self-retracting lifeline. The force-reduction mechanism absorbs vertical forces produced by the lower torso webbing strap resulting from the attachment of tools or equipment to the lower torso webbing strap. The arrangement of the apparatus also promotes increased flexibility between the shoulder safety straps and the lower torso webbing straps torso safety strap, thereby reducing wearer fatigue.

### FIELD

The present disclosure, in some embodiments, relates to a component for a safety harness system to be worn by a worker operating at potentially harmful or deadly heights.

### BACKGROUND

Fall protection equipment is an aspect of safety equipment utilized by workers who are operating at potentially harmful or deadly heights. In addition to providing peace of mind to workers, workers use personal fall arrest or protection devices when working at elevations at or above 4-6 feet above the ground. Properly set-up fall protection equipment ensures that when a worker falls from an elevated position, their body is stopped prior to contact with the ground or any other objects below.

One element of a fall protection system utilized by workers is a safety harness system, which includes a set of straps that are typically worn around the operator's waist, shoulders, and groin area. Typically, the safety harnesses will include multiple straps, with each being adjustable relative to each other. This effectively creates a cradle to prevent the body from slipping out of the harness in the case of a fall. Under normal conditions, a worker will put the safety harness on their body before reaching the elevated point and adjust the straps as necessary in an effort to optimize comfort. Once the safety harness is put on and adjusted, the wearer will attach a self-retracting lifeline (“SRL”), personal self-retracting lifeline (“SRL-P”), lanyard, or other fall arrest device to themselves, along with any additional equipment or a tool belt before ascending to the elevated position.

At a high level, an SRL and an SRL-P perform essentially the same function of connecting a wearer's harness to an anchor point using a retractable cord or line. Each operate in a similar manner to a seatbelt, wherein the retractable cord or line is stored within a housing. A mechanism within the housing allows the cord or line to be pulled out and retracted quickly without requiring the use of a release mechanism. However if the cord is pulled abruptly, such as in the case of a fall, the internal braking mechanism within the housing automatically engages and an energy absorbing mechanism rapidly stops the line from being pulled outward any further.

Although they perform essentially the same function, an SRL and an SRL-P are distinct devices. Generally, an SRL is a larger apparatus which is affixed to a permanent anchorage point, typically above the wearer. An SRL housing is intended to remain stationary with respect to the anchor point, and the housing is typically sized larger than SRL-P housings in order to accommodate greater lengths of cords. The end of the cord that pulls out of an SRL housing will usually attach directly to the harness, often on a D-ring, using an SRL hook. This hook must be of sufficient strength to support the weight of the wearer in case of a fall. As a result of the increased length of cord contained within the housing, the SRL provides a substantial distance of travel in relation to the SRL housing. Because the wearer does not need to bear the weight of the SRL housing, and because SRL's generally contain a substantial length of cord, SRL's are designed for a worker to remain attached to throughout their entire time at the elevated position without necessitating any disconnection or reconnection.

In comparison, an SRL-P is a smaller housing which remains permanently affixed to the wearer and contains a shorter distance of cord. The SRL-P housing generally attaches directly to the harness such that the weight of the SRL-P is supported by the wearer's harness. Often, a worker will wear two separate SRL-P devices which increases the safety in case of a fall but also causes additional fatigue to the wearer as a result of the weight of the SRL-P devices. While the SRL-P device is attached directly to the harness, the retracting cord is intended to be connected to a variety of attachment points including a horizontal lifeline, a vertical lifeline, or any other anchorage point accessible to the wearer. Because the SRL-P's contain shorter cords, they are designed for the wearer to attach, detach, and reattach to multiple anchorage points while working at the elevated position. Lastly, while a traditional SRL attaches to a D-ring on the harness, SRL-P devices are designed to attach to an SRL-P port intended to help support the weight of the SRL-P housing and to ensure that the SRL-P does not twist or get tangled.

Because SRL and SRL-Ps are intended to break the fall of a wearer, they attach to a safety harness system. Typical safety harness systems employ a harness keeper as the attachment point for the SRL and SRL-P. Traditional harness keepers may utilize a dorsal pad as the chassis for which all other components are attached or mounted onto. In most harness keepers, this dorsal pad is worn on the upper back, just below the wearer's shoulder blades. As the central point for a harness system, an ideal harness keeper includes attachment points for shoulder safety straps, the lower torso webbing straps, the SRL-P, and a D-ring for traditional SRLs, lanyards, or additional fall arrest equipment.

Although the harness keeper is a necessary aspect of a safety harness system, traditional harness keepers have a number of disadvantages. For example, in order for a safety harness to properly cradle the body in case of a fall, the harness must be snuggly attached over the body to prevent any body parts from slipping out, thereby defeating the purpose of a harness.

An unintended consequence of the harness firmly cradling the body is that it may cause fatigue and limit the wearer's flexibility. For example, because the harness must be securely wrapped on a wearer's thighs and shoulders in order to fully encompass the body, and because most harness keepers utilize a rigid structure, traditional harness keepers do not provide for any flexibility between the upper and lower portions of the harness. As a result, certain movements made by the wearer result in unpleasant pulling of the harness across the body. By way of example, in a traditional rigid harness keeper, the wearer may experience unpleasant upward forces to their thigh and groin area when raising their arms up while working due to the rigidity of traditional harness keepers. Likewise, a wearer may experience discomfort in their torso and lower back regions when bending to the side, as a result of the upper straps of their harness pulling the lower straps due to the rigid nature of traditional harness keepers.

There are also drawbacks to having a D-ring attachment point for traditional SRL's and other various safety equipment. For example, the D-ring attachment point on traditional harness keepers is susceptible to folding flat against the dorsal pad, thereby making it difficult for the wearer to access and attach additional safety equipment. One such solution to this is to incorporate a spring system into the D-ring specifically, which biases the D-ring to be outward facing at all times. However, even the use of a biasing spring system may have numerous disadvantages. For example, under certain circumstances it may be preferred to have the D-ring lying flat, such as when there is a risk of the D-ring catching on protruding objects. Likewise, the use of a spring system which biases the D-ring to stand upward does not alleviate any of the fatigue caused by the weight of the D-ring and any attached equipment, including the fatigue resulting from the repetitive impacts created by the D-ring and equipment such as the SRL hook bouncing as the wearer moves throughout the day.

Another drawback is that traditional harness keepers do not account for the potential weight of an attached tool belt. In some cases, a worker will wear a tool belt that is separate from the harness, thereby placing the majority of the weight of the tool belt, often upwards of thirty pounds or more, onto the lower back and torso region. Alternatively, a worker may attach their tool belt to their harness, however then the weight of the tool belt is distributed throughout the harness and subject to the weight and lack of flexibility issues previously disclosed.

Another drawback with traditional harness keepers is that they do not address the weight of SRL-P housings. Although an SRL-P housing is necessary to store and retract safety lines to keep them out of a worker's way, this feature comes at the cost of the weight and size of the SRL-P housing which is typically attached directly to the harness keeper and may bounce or vibrate as the worker moves. This repetitive bouncing resulting from the weight of the SRL-P being attached directly to the harness keeper causes unnecessary fatigue to the wearer. In addition to the impacts from the weight of the SRL-P and the weight of the SRL hook, the weight and impacts from a worker's tool belt are also typically concentrated at the harness keeper.

As a necessary component of a safety harness system, the harness keeper must be worn at all times that a worker is operating at an elevated position. Likewise, the SRL-P and toolbelts are also typically worn for extended periods of time when working at elevated positions. The weight of this equipment, and the associated forces resulting from the repetitive impacts of a bouncing tool belt, SRL-P, SRL hook, D-ring, is detrimental to the wearer and likely to cause unnecessary fatigue and potential long-term damage to the wearer's body, particularly when worn for extended periods of time. Said fatigue and long-term damage may also result in an increased likelihood of accidents and repetitive stress injuries.

Current solutions to alleviate the weight and impacts resulting from the harness keeper and its peripheral components involve the use of a rigid weight distribution system. These rigid weight distribution systems take the weight of the dorsal pad, including the weight of the SRL-P, SRL hook, D-ring, and any other attached equipment and distribute the weight from the wearer's dorsal section down to their lumbar section via a rigid support member. While said rigid weight distribution system does reduce the weight felt at the wearer's dorsal section, simply shifting a portion of the weight to the wearer's lumber section only results in additional fatigue and discomfort to the lumbar section. Likewise, because most available weight distribution systems rely on a rigid support member, the systems do not provide any impact absorbance from the forces caused by bouncing or loosely attached SRL-Ps or other safety equipment. These short, repetitive impacts from the weight of the worn equipment further result in increased fatigue. Likewise, none of these proposed solutions simultaneously increase overall flexibility to the harness system for the wearer.

In view of the issues faced by wearers of existing fall protection devices, there is a need for more user-friendly, comfortable, and secure components for harness systems.

### BRIEF SUMMARY

Embodiments of the present disclosure addresses the above-identified challenges by introducing a harness keeper designed for use in a safety harnesses system. The disclosed harness keeper incorporates multiple shock absorption features, providing a harness keeper that can be used for secure attachment to a traditional SRL, an SRL-P, and various other safety equipment while simultaneously providing a level of comfort not previously available from existing harness keepers, making it suitable for a wide range of applications where safety is paramount. By incorporating shock absorption systems, harness keepers can offer improved performance, safety, and user comfort.

Moreover, the present disclosure presents an exemplary harness keeper for reducing wearer fatigue while in use as a necessary component of a wearable safety harness system apparatus. More specifically, embodiments of the present invention include a harness keeper to be worn on the dorsal section of a wearer's back and which operates as a central chassis capable of attachment to the shoulder safety straps, an SRL hook, the SRL-P, and the lower torso safety straps.

Accordingly, embodiments of the present disclosure include a shock absorbing mechanism to counteract the impacts caused by the weight of an attached SRL-P, the D-ring, the SRL hook, other attached equipment, the worker's tool belt, and any other devices worn or attached to the back of the safety harness. According to some other embodiments, the shock absorbing mechanism of the present disclosure also helps increase flexibility within the harness system without compromising safety.

### BRIEF DESCRIPTION OF THE DRAWINGS

FIG. 1 illustrates a perspective view of an example of the presently disclosed harness keeper for use in a wearable safety harness system, according to one embodiment.

FIG. 2 illustrates an exploded view of an example of the presently disclosed harness keeper for use in a wearable safety harness system, according to one embodiment.

FIG. 3 illustrates a perspective view of a dorsal chassis of the presently disclosed harness keeper for use in a wearable safety harness system, according to one embodiment.

FIG. 4 illustrates a front view of the dorsal chassis of the presently disclosed harness keeper for use in a wearable safety harness system, according to one embodiment.

FIG. 5 illustrates a back view of the dorsal chassis with one or more shoulder straps and one or more lower torso wraps of the presently disclosed harness keeper for use in a wearable safety harness system, according to one embodiment.

FIG. 6 illustrates an exploded view of an attachment subassembly of the presently disclosed harness keeper for use in a wearable safety harness system, according to one embodiment.

FIG. 7 illustrates a perspective view of a slider component of the presently disclosed harness keeper for use in a wearable safety harness system, according to one embodiment.

FIG. 8 illustrates a perspective view of the SRL-P port component of the presently disclosed harness keeper for use in a wearable safety harness system, according to one embodiment.

FIG. 9A illustrates a perspective view of the force reduction mechanism attached to the dorsal chassis of the presently disclosed harness keeper for use in a wearable safety harness system, according to one embodiment.

FIG. 9B illustrates a perspective view of the attachment subassembly attached to the force reduction mechanism of the presently disclosed harness keeper for use in a wearable safety harness system, according to one embodiment.

FIG. 10 illustrates a perspective view of a force-reduction mechanism component of the presently disclosed apparatus for reducing wearer fatigue for use in a wearable safety harness system, according to one embodiment.

FIG. 11 illustrates a perspective view of an example of a user wearing the presently disclosed harness keeper for use in a wearable safety harness system, according to one embodiment.

FIG. 12 illustrates a perspective view of an example of the presently disclosed harness keeper for use in a wearable safety harness system attached to a tool belt system, according to one embodiment.

### DETAILED DESCRIPTION

A harness keeper for reducing wearer fatigue for use in a wearable safety harness system, according to one embodiment is presented. In the following description, for purposes of explanation, numerous specific details are set forth in order to provide a thorough understanding of the present disclosure. It will be evident, however, to one skilled in the art that the present disclosure may be practiced without these specific details. The present disclosure is to be considered as one or more examples only and is not intended to limit the disclosure to the specific embodiments illustrated by the figures or description below.

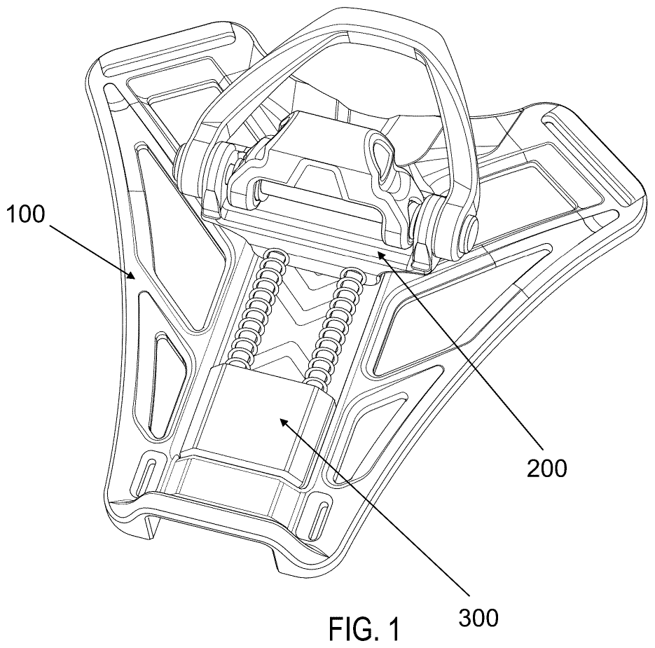

Referring now to FIG. 1, a perspective view of the harness keeper for in a wearable safety harness system, according to one embodiment is presented. In certain embodiments, the apparatus may contain a dorsal chassis 100, an attachment subassembly 200 and a force-reduction mechanism 300. In certain embodiments, the attachment subassembly 200 may be attached to the force-reduction mechanism 300 which may be integrated into the dorsal chassis 100. As will be explained in more detail below, this arrangement permits controlled, impact-dampened vertical movement of the attachment subassembly 200 relative to the dorsal chassis 100. In certain embodiments, the presently disclosed apparatus may be designed to be integrated into a safety harness system for workers operating at elevated positions. More specifically, the presently disclosed apparatus may operate as an attachment point for a self-retracting lifeline device (SRL), an attachment point for other safety equipment, and as a central junction for the flexible yet secure connection between the various straps that form a wearable harness. In some embodiments, the harness keeper may also be attached to the tool belt, thereby dampening the impact from a bouncing tool belt felt by a wearer, although this is not a necessary connection. In order to allow the worker to have room in front of them to use both of their hands with an unobstructed view, and in order to prevent injury to the wearer's extremities including to the head, neck, and face, the presently disclosed apparatus may be worn on the back of the wearer, typically in the dorsal section just below and between the shoulder blades. This keeps the SRL device and other safety equipment securely attached, while ensuring the operators hands do not get tangled in the devices.

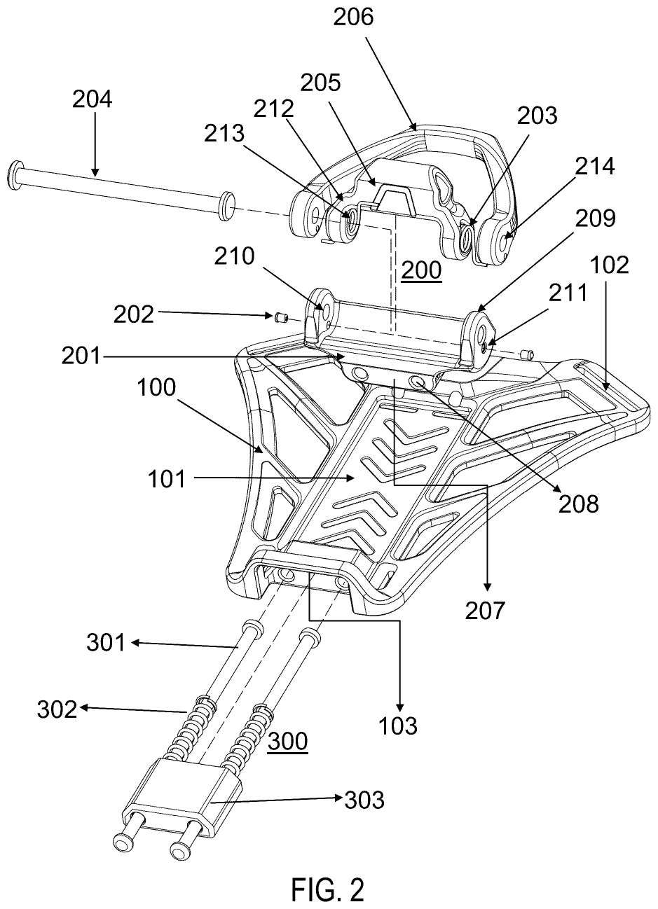

Referring now to FIG. 2, an exploded view of an example of the presently disclosed harness keeper is presented. In certain embodiments, arrangement of the components of the harness keeper permits the secure attachment of SRLs, tool belts, and other safety equipment, facilitates shock absorption of impacts caused by the movement of these devices, and increases flexibility between the shoulder straps and lower torso straps of the wearer. Each of these features may increase the wearer's comfort, reduce fatigue, and ensure a highly secure connection between the harness and any safety equipment in order to maintain the highest standards of safety. In order to achieve these goals, the following components may be utilized. The dorsal chassis 100 may include a center channel 101, a pair of top slots 102, and a bottom guide slot 103. The attachment subassembly 200 may include a slider 201, a press fit detent 202, a torsion spring, 203, a rivet 204, a SRL-P port 205, a D-ring 206, a slider tab 207, slider tab port holes 208, slider arms 209, slider arm port holes 210, a slider detent port 211, SRL-P port arms 212, SRL-P port holes 213, and D-ring port holes 214. Also shown in FIG. 2 is the force reduction mechanism 300, which may include one or more guide rivets 301, one or more compression springs 302, and a spring cover 303.

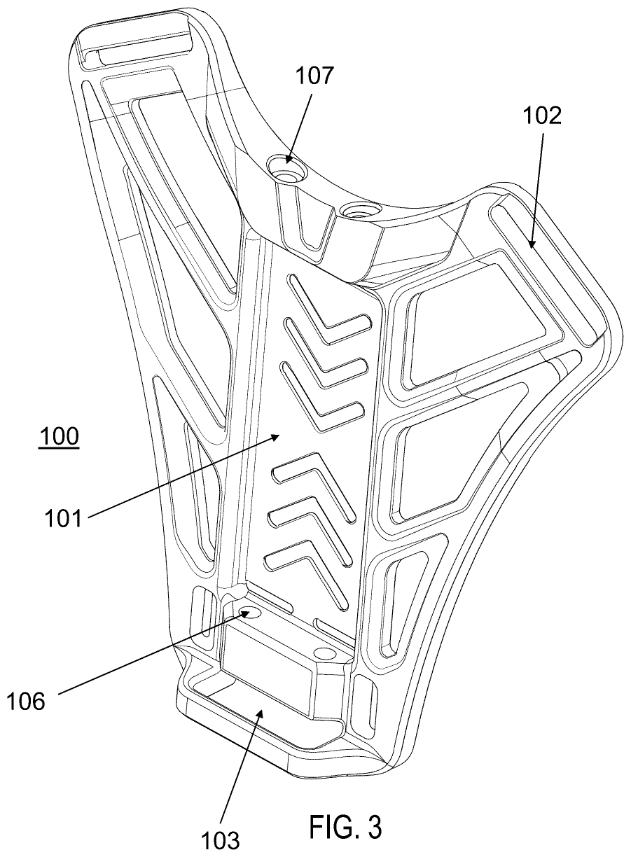

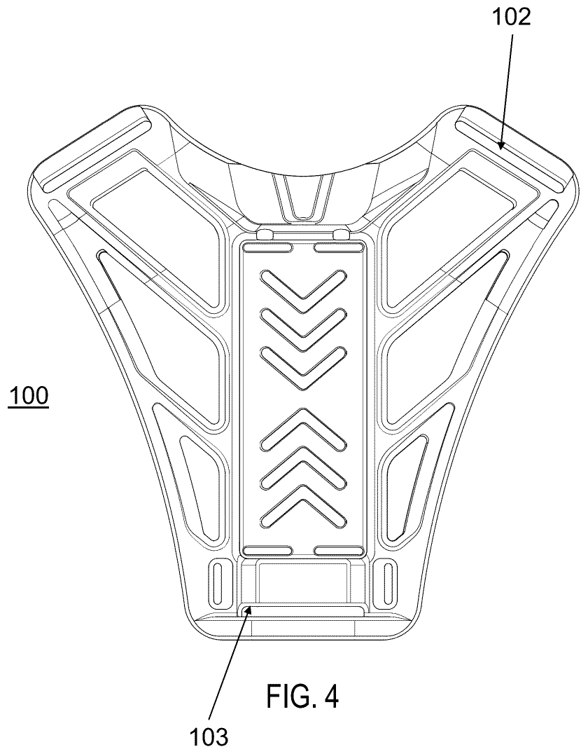

Referring now to FIGS. 3 and 4, a perspective view and a front view of one embodiment of the dorsal chassis 100 is presented. In certain embodiments, the dorsal chassis 100 may be a generally planar chassis designed to rest flush against the dorsal portion of a wearer's back. According to other embodiments, the dorsal chassis may come in various sizes to fit the dorsal portion of a variety of wearer's backs. Referring still to FIGS. 3 and 4, in certain embodiments the dorsal chassis 100 may also include one or more lower guide rivet ports 106 and one or more upper guide rivet ports 107.

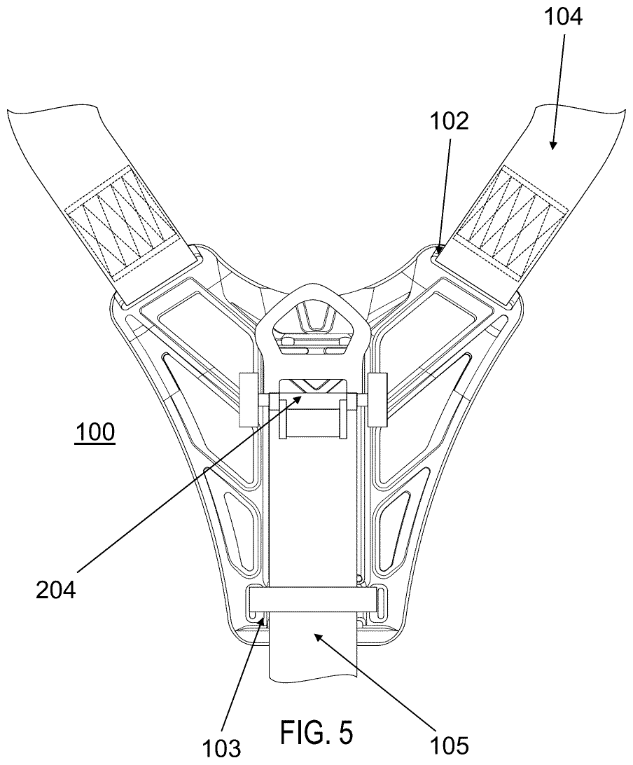

As shown in FIG. 5, the dorsal chassis 100 may include one or more top slots 102 and a bottom guide slot 103. The top slots 102 may be sized to accommodate the shoulder safety harness straps 104, while the bottom guide slot 103 may be sized to accommodate the lower torso safety strap 105. In certain embodiments, the shoulder safety harness straps 104 may be looped through the top slots 102 and sewn back on to themselves. Other methods of attaching the shoulder safety harness strap to itself after it has been looped through the top slots 102 are also contemplated. In some embodiments, the lower torso safety strap 105 may not attach directly to the bottom guide slot 103, but rather is fed through the bottom guide slot 103, looped around the rivet 204 of the attachment subassembly 200 and is sewn back onto itself. In some embodiments, the lower torso safety strap 105 may also be fed through a strap adjuster to ensure that a proper length of the lower torso safety strap 105 is provided to be sewn back onto itself without excess. Rather than acting as an attachment point for the lower torso safety strap 105, the bottom guide slot 103 in some embodiments may be utilized to keep the lower torso safety strap 105 flush against the dorsal chassis 100 and to prevent unwanted twisting or rolling of the lower torso safety strap 105.

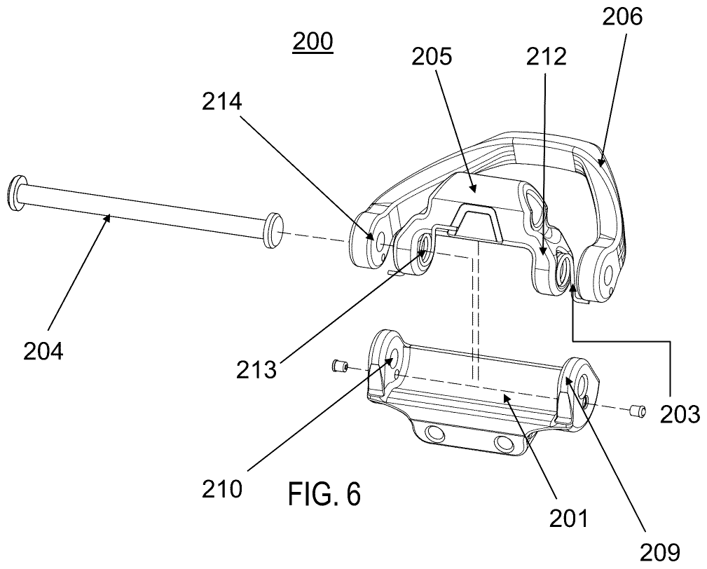

Turning now to FIG. 6, an exploded view of one embodiment of the attachment subassembly 200 is presented. In certain embodiments, one purpose of the attachment subassembly 200 is to provide a location for the SRL and other safety equipment, such as lanyards, connectors, and other restraint devices to be attached to the harness keeper. To achieve this purpose, the attachment subassembly 200 may include an SRL-P port 205 and a D-ring 206. In some embodiments, the SRL-P port 205 may be designed to accommodate specific SRL-P models, and in other embodiments it may be a universal SRL-P port. The D-ring 206 may be the intended attachment point for a traditional SRL, along with any other auxiliary safety equipment such as a lanyard or connector. In certain embodiments, a torsion spring 203 may be utilized to maintain the SRL-P port 205 in an outward direction generally perpendicular to the dorsal chassis 100 so that it is more easily accessed by the wearer when being worn, and so the torsion spring 203 can provide additional shock absorbance from the weight of attached SRL-Ps. Referring still to FIG. 6, according to some embodiments the attachment subassembly 200 may be designed so that the slider 201, the torsion spring 203, the SRL-P port 205, and the D-ring 206 are all attached relative to each other via a single rivet 204 or other connecting device. More specifically, the rivet 204 may be inserted through the D-ring port holes 214, through the slider arm port holes 210 on the slider arms 209, through the torsion spring 203, and through the SRL-P port arm holes 213 on the SRL-P port arms 212.

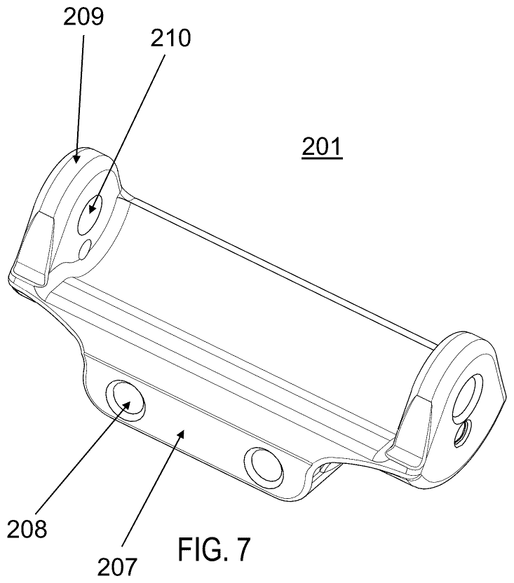

Turning to FIG. 7, a perspective view of one embodiment of the slider 201 is presented. In some embodiments, the slider 201 may act as the base of the attachment subassembly 200 and may facilitate the connection of the attachment subassembly 200 to the dorsal chassis 100. According to some embodiments, the slider 201 may include a slider tab 207 and one or more slider tab port holes 208. The slider tab 207 is located on the bottom of the slider 200 and may be designed to fit into the center channel 101 of the dorsal chassis 100 as shown in FIG. 1. The slider tab 207 may include one or more slider tab port holes 208, which are sufficient diameter to accept the guide rivets 301 of the force-reduction mechanism 300, thereby allowing the slider to attach directly to the force reduction mechanism 300 as depicted in FIG. 1. The slider 201 may include one or more slider arms 209 extending outwardly away from the slider tab 207. According to some embodiments, each slider arm 209 may include a slider arm port hole 210 which is of sufficient diameter to accommodate the rivet 204 as depicted in FIG. 6.

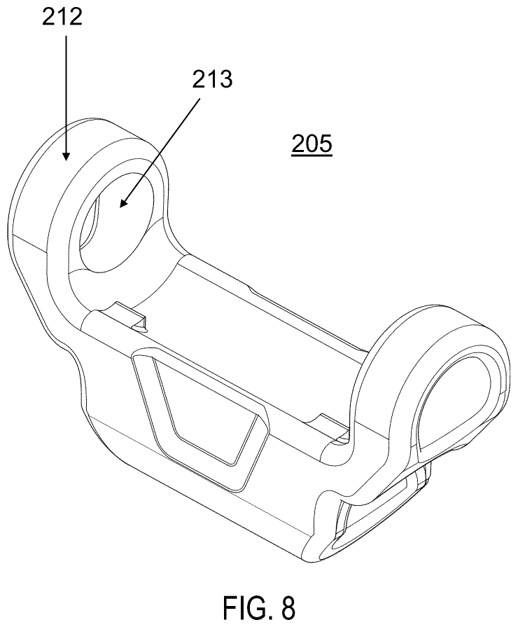

Referring now to FIG. 8, a perspective view of one embodiment of the SRL-P port 205 is presented. In some embodiments, the SRL-P port 205 may include one or more SRL-P port arms 212, each of which may include an SRL-P port arm hole 213 of sufficient diameter to accommodate the rivet 204 and one end of the torsion spring 203 as depicted in FIG. 6.

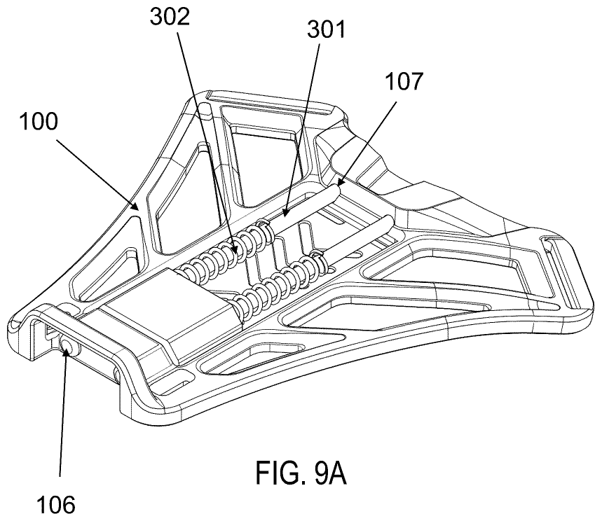

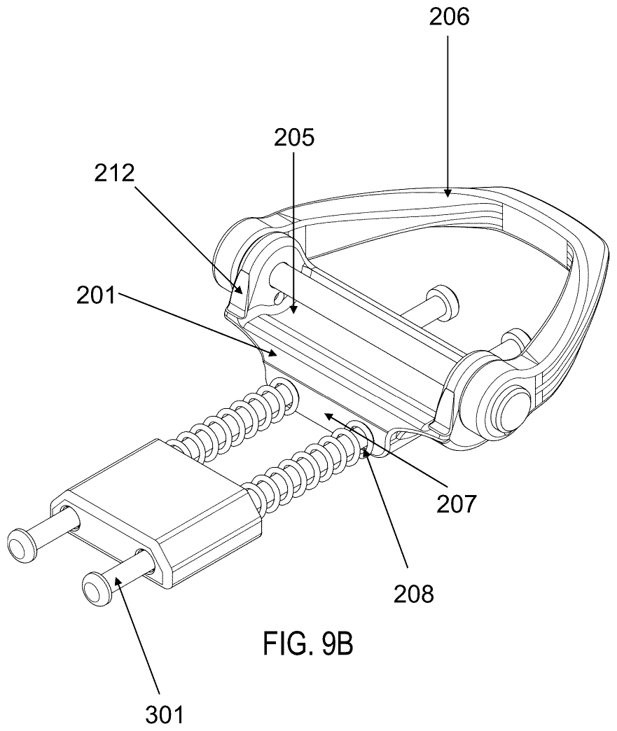

Referring now to FIG. 9A, a perspective view of the force reduction mechanism 300 attached to the chassis 100 according to one embodiment is presented, while FIG. 9B depicts perspective view of the attachment subassembly 200 attached to the force reduction mechanism 300. In these figures, the slider 201 may act as the base of the attachment subassembly 200 and connects the entire attachment subassembly 200 to the dorsal chassis 100. More particularly, the slider tab 207 may fit into the center channel 101, and the guide rivets 301 of the force-reduction mechanism 300 may fit through the slider tab port holes 208 such that the slider 201 can freely ride up and down the guide rivets 301 within the center channel 101. The SRL-P port arms 212 of the SRL-P port 205 may be designed to fit within the space between the slider port arms 210 of the slider 201. According to some embodiments, in between the SRL-P port arms 212 and the slider arms 209, a torsion spring 203 may be inserted to bias the SRL-P port 205 in an upward direction for easy access for a wearer. In some embodiments, the D-ring portholes 214 of the D-ring 206 may fit against the outside of the SRL-P port arms 212. In order to keep the D-ring 206 from swinging freely, in some embodiments a press fit detent 202 is inserted through the slider detent port 211 which causes the press fit detent 202 to contact the D-ring 206. The contact between the press fit detent 202 and the D-ring 206 may allow the D-ring 206 to pivot when a force is applied, but also ensures the D-ring 206 remains stationary during normal operations.

Referring back to FIG. 6, in certain embodiments, the entire attachment subassembly 200 may be held together by a rivet 204 which passes through the D-ring port holes 214, the SRL-P port arm holes 213, the torsion springs 203, and the slider arm port holes 212. The rivet 204 ensures that each component of the entire attachment subassembly 200 remains securely attached each other, while also permitting the D-ring 206 and the SRL-P port 205 to pivot in relation to the rivet 204.

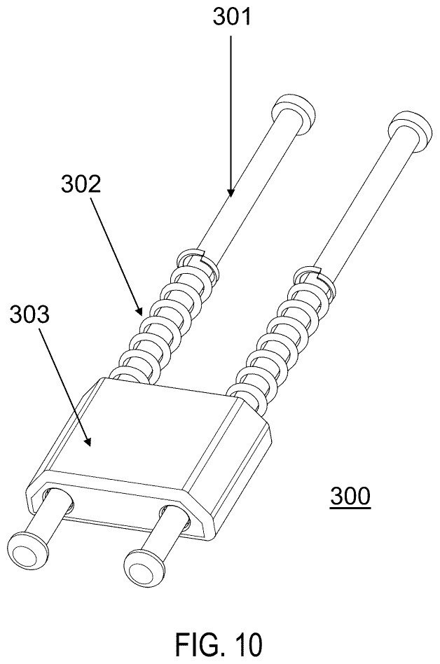

Referring now to FIG. 10, a perspective view of the force reduction mechanism 300, according to some embodiments, is presented. In certain embodiments, the force-reduction mechanism 300 may include one or more guide rivets 301, one or more compression springs 302, and a spring cover 303. In certain embodiments the compression springs 302 may be fit over the guide rivets, 301, and the spring cover 303 may fit over a portion of the compression springs 302. Other methods of protecting the compression springs 302 and the guide rivets 301 may be contemplated.

Referring back to FIG. 9A, the attachment of the force-reduction mechanism 300 to the dorsal chassis is shown 100 according to one embodiment. The guide rivets 301 may be designed to be inserted and held in place through the lower guide rivet ports 106 and the upper guide rivet ports 107 of the dorsal chassis 100. The compression springs 302 and the spring covers 303 may be placed on the guide rivets 301 between the lower guide rivet ports 106 and the upper guide rivet ports 107, and the guide rivets 301 may be fed through the slider tab port holes 208. In this arrangement, the attachment subassembly 200, via connection to the slider 201, is free to slide up and down the guide rivets 301 located within the center channel 101 of the dorsal chassis 100. The compression springs 302, located atop the guide rivets 301, may help dissipate and counteract any downward forces from the attachment subassembly 200 throughout the entire dorsal chassis 100. Such downward forces on the attachment subassembly 200 may include the impacts caused by the bouncing weight of the SRL-P and other safety equipment. According to some embodiments, the compression springs 302 may reduce wearer fatigue by reducing the felt effects of the impacts caused by the bouncing weight of the SRL-P and any other safety equipment.

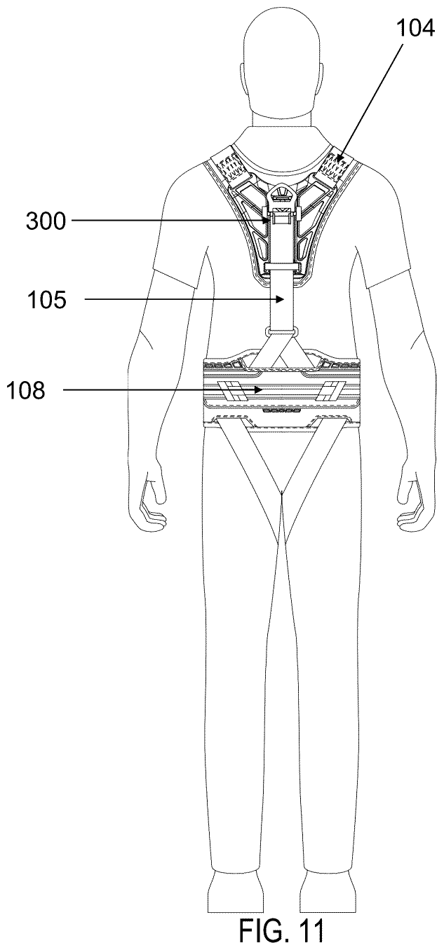

Referring now to FIG. 11, a perspective view of the apparatus for reducing wearer fatigue for use in a wearable safety harness system is depicted in use according to some embodiments. As shown, the shoulder safety harness straps 104 may be looped through the top slots 102 and sewn back onto themselves. The lower torso safety strap 105 may be fed up through the bottom guide slot 103, looped around the rivet 204, and sewn back onto itself. In some embodiments, the lower torso safety strap may also be fed through a strap adjuster, thereby ensuring the proper placement of the dorsal assembly on the wearer's back. In this arrangement, the compression springs 302 may also provide shock absorbance and help counteract the downward forces felt by a wearer resulting from the lower torso strap 105.

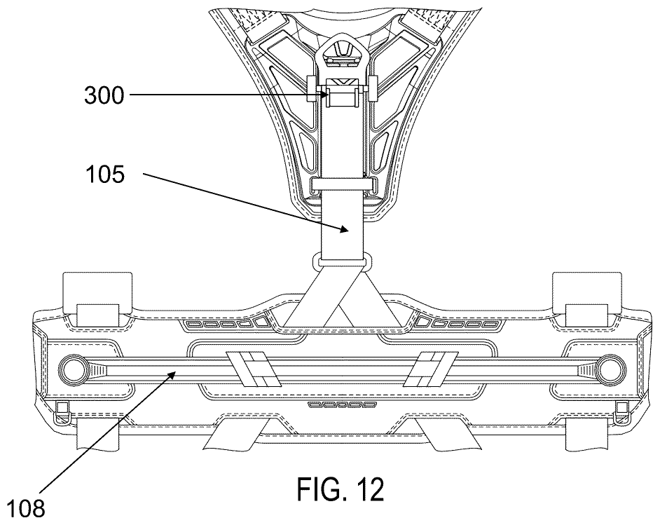

In some embodiments, such as that depicted in FIGS. 11 and 12, the lower torso safety strap 105 may be attached to a tool belt 108. The tool strap 108 may be designed to accommodate tools and other equipment. In some embodiments, the force-reduction mechanism 300 helps reduce the forces felt by a wearer resulting from the weight of the tool belt, thereby reducing wearer fatigue and allowing for extended use. Additionally, because the lower torso safety straps 105 are not directly connected to the shoulder safety harness straps 104, but rather through the apparatus described herein, there may be an added benefit of increased flexibility for the wearer. By way of example, movements by the wearers arms will not pull the lower torso safety straps 105 upward into the wearer as due to the increased flexibility afforded by the force-reduction mechanism 300. Said increased flexibility, along with the reduction in felt forces from the SRL, other safety equipment, and tool belt each lend to increased comfort and safety for the wearer, and may help reduce back, shoulder, and groin injuries resulting from fatigue or lack of flexibility in traditional safety harness systems.

While various embodiments of the present disclosure have been described in detail, it should be apparent that modifications and variations thereto are possible, all of which fall within the true spirit and scope of the disclosure. For example, various other embodiments may not require all subassemblies to be present, or may include other similar subassemblies. One such example is that the force reduction mechanism may use shock absorbing means other than a compression spring such as a hydraulic, strut, damper, or pneumatic system. Similarly, other embodiments may use different connection mechanisms or orientations for the attachment of the safety straps to the presently disclosed mechanism.

Additionally, various embodiments may utilize multiple of the same subassemblies. For example, certain embodiments may utilize two or more force reduction mechanism, to increase force reduction. Likewise, other embodiments could include multiple sliders, multiple D-rings, and multiple SRL-P ports.

Similarly, other embodiments may include similar force-reduction devices worn on the chest, stomach, or oblique regions for the use in reducing downward forces from tool belts and other worn devices.

Therefore, the foregoing is intended only to be illustrative of the principles of the disclosure. Further, since numerous modifications and changes will readily occur to those skilled in the art, it is not intended to limit the disclosure to the exact construction and operation shown and described. Accordingly, all suitable modifications and equivalents may be included and considered to fall within the scope of the disclosure, defined by the following claim or claims.

The terminology used herein is for the purpose of describing particular embodiments only and is not intended to be limiting of the disclosure. As used herein, the term “and/or” includes any and all combinations of one or more of the associated listed items. As used herein, the singular forms “a,” “an” and “the” are intended to include the plural forms as well as the singular forms, unless the context clearly indicates otherwise. It will be further understood that the terms “comprises” and/or “comprising” when used in this specification, specify the presence of stated features, steps, orientations, elements, and/or components, but do not preclude the presence or addition of one or more other features, steps, operations, elements, components, and/or groups thereof.

Unless otherwise defined, all terms (including technical and scientific terms) used herein have the same meaning as commonly understood by one having ordinary skill in the relevant art. It will be further understood that terms, such as those defined in commonly used dictionaries, should be interpreted as having a meaning that is consistent with their meaning in the context of the relevant art and the present disclosure and will not be interpreted in an idealized or overly formal sense, unless expressly so defined herein.

It will be understood that a number of techniques and steps relating to the disclosure are presented. Each of these has individual benefits and each can also be used in conjunction with one or more, or in some cases all, of the other disclosed techniques. Accordingly, for the sake of clarity, this description will refrain from repeating every possible combination of the individual steps in an unnecessary fashion. Nevertheless, the specification and claims should be read with the understanding that such combinations are entirely within the scope of the inventions and the claims.

What is claimed is:

1. An apparatus for reducing wearer fatigue for use in a wearable safety harness system, the apparatus comprising:
a dorsal chassis configured to engage with one or more shoulder safety straps and a lower torso webbing strap;
a force-reduction mechanism configured to absorb vertical forces produced by the lower torso webbing strap resulting from an attachment of tools or equipment to the lower torso webbing strap; and
an attachment subassembly that is attached to the dorsal chassis via the force-reduction mechanism such that the force-reduction mechanism absorbs vertical forces produced by the weight of a self-retracting lifeline.

2. The apparatus of claim 1 wherein the dorsal chassis includes one or more top slots to attach one or more shoulder safety harness straps to a top portion of the chassis and a bottom guide slot to accept the lower torso safety strap through a bottom portion of the chassis.

3. The apparatus of claim 1 wherein the one or more shoulder safety harness straps are looped through the one or more top slots and sewn back to another one of the one or more should safety harness straps to secure the one or more shoulder safety straps to the dorsal chassis.

4. The apparatus of claim 1 wherein the attachment subassembly comprises a channel configured for adjustable attachment to a self-retracting lifeline attachment point.

5. The apparatus of claim 1 wherein the attachment subassembly comprises a lower torso webbing strap attachment point comprising a rivet to adjustably anchor the lower torso webbing strap to the attachment subassembly.

6. The apparatus of claim 1 wherein the lower torso webbing strap is fed through the bottom guide slot, looped around the rivet, and sewn to onto the lower torso webbing strap in order to attach the lower torso webbing strap to the attachment subassembly.

7. The apparatus of claim 1 wherein the lower torso webbing strap is attached to a tool belt configured to be attached to a waist of a user.

8. The apparatus of claim 1 wherein the force-reduction mechanism is a spring, a pneumatic piston, a hydraulic piston, or a dampener.

9. The apparatus of claim 1 wherein the force-reduction mechanism produces a counterforce to counter any downward force applied to the force-reduction mechanism.

10. The apparatus of claim 9 wherein the downward force comprises cumulative forces resulting from a weight of the self-retracting lifeline and the downward force applied to the lower torso webbing strap resulting from the weight of tools or equipment attached to the tool belt.

11. The apparatus of claim 1 wherein the attachment subassembly is attached directly to the force-reduction mechanism such that the attachment subassembly may move vertically relative to the force-reduction.

12. A method for reducing wearer fatigue for use in a wearable safety harness system, the method comprising:
engaging, via a dorsal chassis, with one or more shoulder safety straps and a lower torso webbing strap;
absorbing, via a force-reduction mechanism, vertical forces produced by the lower torso webbing strap resulting from an attachment of tools or equipment to the lower torso webbing strap; and
attaching, via an attachment subassembly, to the dorsal chassis via the force-reduction mechanism such that the force-reduction mechanism absorbs vertical forces produced by the weight of a self-retracting lifeline.
